(19) United States
(12) Patent Application Publication
(10) Pub. No.: US 2012/0057102 A1
(43) Pub. Date: Mar. 8, 2012

(54) BACKLIGHT MODULE

(75) Inventors: Qian Cao, Shenzhen (CN); Poying Lin, Shenzhen (CN); Yicheng Kuo, Shenzhen (CN); Chechang Hu, Shenzhen (CN)

(73) Assignee: SHENZHEN CHINA STAR OPTOELECTRONICS TECHNOLOGY CO., LTD., Shenzhen (CN)

(21) Appl. No.: 12/996,248

(22) PCT Filed: Sep. 2, 2010
(86) PCT No.: PCT/CN10/76586

§ 371 Date: Dec. 3, 2010

(51) Int. Cl. G02F 1/13357

(52) U.S. Cl. 349/65; 349/69

(57) ABSTRACT

The present invention discloses a backlight module, used for a liquid crystal display apparatus. The backlight module comprises a back plate, positioned at the bottom of the backlight module; a display area being in the liquid crystal display apparatus in accordance with the back plate and overlapping therewith, and the display area has a display area center line; and a plurality of LEDs classified to belong to several bright bins respectively and the display area center line has a center corresponding to the LEDs, wherein the LEDs belonging to a higher bright bin are positioned closer to the center and the LEDs belonging to a lower bright bin are positioned farther to the center. The LED backlight module of the present invention can raise the usage rate of LEDs and reduce the cost efficiently.

### BACKGROUND OF THE INVENTION

1. Field of the Invention

The present invention generally relates to a backlight module and a liquid, and more particularly to a LED backlight module capable of raising the usage rate of LEDs.

2. Description of Prior Art

Nowadays, a liquid crystal display (LCD) is mainly manufactured by producing a backlight module first constructed by a backlight source, a plastic frame and a diffusion plate, and then assembling the backlight module with a liquid crystal front panel and a front frame to construct a LCD module for manufacturing a final product. Generally, the backlight module which the backlight sources of the liquid crystal display utilizes Cold Cathode Fluorescent Lamps (CCFL) is now substantially replaced by a LED backlight module because the properties of the low power consumption and mercury free of the LED backlight module. Consequently, the CCFL backlight module will be history ultimately. The LED backlight module will certainly replace overall.

Now, the LEDs are generally laid out on the light bars in the backlight module utilizing the LEDs as the backlight sources. A predetermined specification will be introduced to select the mass-production LEDs and classify thereof. Generally, the indexes of performance used for classifying the LEDs includes the brightness, the chrominance, the wavelength or the positive voltage bin of the LEDs. Accordingly, the LEDs can be classified by the aforesaid indexes. The display manufacturer generally selects the LEDs belonging to a major bin for being laid out on the light bars. On the other hand, the backlight uniformity of the display apparatus is extremely severe, and essentially the range of selecting the LEDs for the display manufacturer is narrowly drawn. Therefore, the ratio of the selected LEDs in the mass-production LEDs inevitably becomes too small. Accordingly, the cost of the backlight module is high and the LEDs cannot be fully utilized to reduce the cost.

Consequently, there is a need to provide a LED backlight module and the LED configuration method to solve the existing issues of prior art.

### SUMMARY OF THE INVENTION

The present invention provides a backlight module, which the LED configuration method is configuring the LEDs corresponding the bright bins of the LEDs.

For realizing the aforesaid objective of the present invention, the present invention provides a backlight module and a liquid crystal display apparatus. The backlight module comprises a back plate, positioned at the bottom of the backlight module; a display area, being in the liquid crystal display apparatus in accordance with the back plate and overlapping therewith, and having a display area center line; and a plurality of LED, classified to belong to several bright bins respectively and the display area center line has a center corresponding to the LEDs, wherein the LEDs belonging to a higher bright bin are positioned closer to the center and the LEDs belonging to a lower bright bin are positioned farther to the center.

With the LED backlight module and the liquid crystal display apparatus manufactured according to the present invention, not only the usage rate of the LEDs utilized for the liquid crystal display apparatus can be raised, but also the limitation of using one set of LEDs, which belong to the same bin in demand is no longer existing. Accordingly, the usage rate of the LEDs utilized for manufacturing the liquid crystal display apparatus and the backlight module can be raised and the cost can be reduced.

### BRIEF DESCRIPTION OF THE DRAWINGS

FIG. 1 shows a diagram of a LED backlight module according to the first embodiment of the present invention;

FIG. 2 shows a diagram of a LED backlight module according to the second embodiment of the present invention;

FIG. 3 shows a diagram of a LED backlight module according to the third embodiment of the present invention;

FIG. 4 shows a diagram of a LED backlight module according to the fourth embodiment of the present invention;

FIG. 5 shows a diagram of a LED backlight module according to the fifth embodiment of the present invention;

FIG. 6 shows a diagram of a LED backlight module according to the sixth embodiment of the present invention;

FIG. 7 shows a diagram of a LED backlight module according to the seventh embodiment of the present invention;

FIG. 8 shows a diagram of a LED backlight module according to the eighth embodiment of the present invention;

FIG. 9 shows a diagram of a LED backlight module according to the ninth embodiment of the present invention; and

FIG. 10 shows an explanation diagram of raising a usage rate of the LEDs according to the present invention.

### DETAILED DESCRIPTION OF THE INVENTION

For a better understanding the aforementioned content of the present invention, preferable embodiments are illustrated in accordance with the attached figures for further explanation:

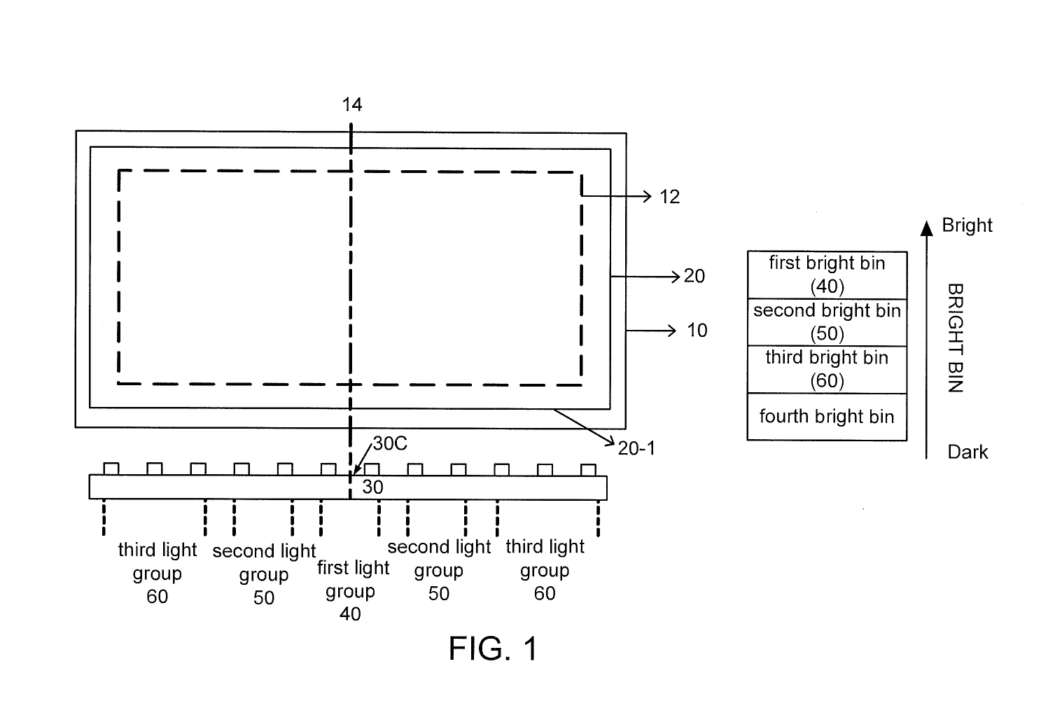

Please refer to FIG. 1, which shows a diagram of a LED backlight module according to the first embodiment of the present invention. The LED backlight module according to the first embodiment of the present invention is a side light type LED backlight module, used for a liquid crystal display apparatus. As shown in the right of FIG. 1, a diagram of that a plurality of LEDs, classified according to bright bin is disclosed. The brightness of the first bright bin is the highest. The brightness of the fourth bright bin is the lowest. The LEDs 40 belong to the first bright bin. The LEDs 50 belong to the second bright bin. The LEDs 60 belong to the third bright bin. The LEDs belonging to the fourth bright bin will not be used. The LEDs 40 are arranged as a first light group. The LEDs 50 are arranged as a second light group. The LEDs 60 are arranged as a third light group.

In this embodiment, the LED backlight module comprises a back plate 10, a light guide plate 20, a light bar 30 and a plurality of LEDs 40-60. The back plate 10 is positioned at the bottom of the LED backlight module. The light guide plate 20 is positioned on the back plate 10 in accordance with a display area 12 of the liquid crystal display apparatus and overlaps therewith. The display area 12 has a display area center line 14 (AA area center line). The back plate 10 has an incident side perpendicular to the display center line 14. The incident side has a position center 30C. The light bar 30 is laid out on the back plate 10 at the incident side of the LED backlight module and faces an incident surface 20-1 of the of the light guide plate 20. The plurality of LEDs belonging to different bright bins is positioned on the light bar 30. The incident surface 20-1 of the light guide plate 20 is a plane. In this embodiment, the LEDs 40 (the first light group) belonging to the highest bright bin are positioned closest to the center 30C. The LEDs 60 (the third light group) belonging to the lowest bright bin are positioned farthest to the position center 30C. The LEDs 50 (the second light group) are positioned among the LEDs 40 (the first light group) and the LEDs 60 (the third light group).

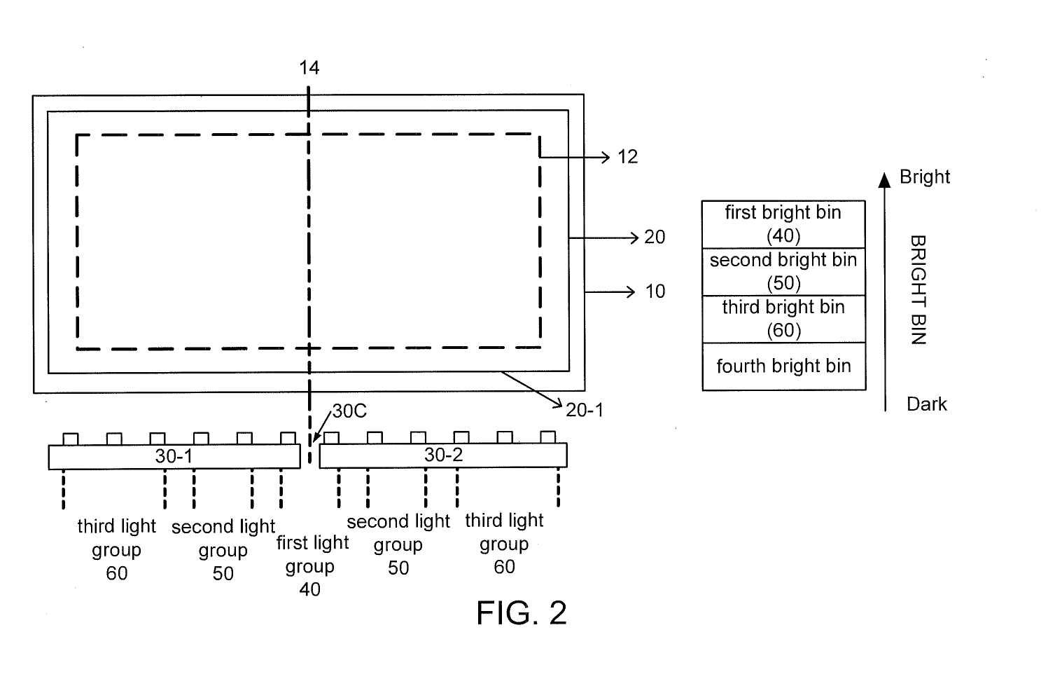

Please refer to FIG. 2. FIG. 2 shows a diagram of a LED backlight module according to the second embodiment of the present invention. The backlight module in this embodiment is a side light type LED backlight module. As shown in the right of FIG. 2, a diagram of that a plurality of LEDs, classified according to bright bin is disclosed. The brightness of the first bright bin is the highest. The brightness of the fourth bright bin is the lowest. The LEDs 40 belong to the first bright bin. The LEDs 50 belong to the second bright bin. The LEDs 60 belong to the third bright bin. The LEDs belonging to the fourth bright bin are darkest and therefore will not be used. The LEDs 40 are arranged as a first light group. The LEDs 50 are arranged as a second light group. The LEDs 60 are arranged as a third light group.

In this embodiment, the LED backlight module comprises a back plate 10, a light guide plate 20, a light bar 30-1, a light bar 30-2 and a plurality of LEDs 40, 50, 60. The back plate 10 is positioned at the bottom of the LED backlight module. The light guide plate 20 is positioned on the back plate 10 in accordance with a display area 12 of the liquid crystal display apparatus and overlaps therewith. The display area 12 has a display area center line 14 (AA area center line). The back plate 10 has an incident side perpendicular to the display center line 14. The incident side has a position center 30C. The light bar 30-1 and light bar 30-2 are laid out on the back plate 10 at the incident side of the LED backlight module and faces an incident surface 20-1 of the of the light guide plate 20. The light bar 30-1 and light bar 30-2 are symmetrically laid out regarding the position center 30C on the back plate 10 at the incident side of the LED backlight module. The LEDs 40, 50, 60 are positioned on the light bar 30-1 and light bar 30-2 respectively, and face the incident surface 20-1 of the of the light guide plate 20. The incident surface 20-1 of the light guide plate 20 is a plane. In this embodiment, the LEDs 40 (the first light group) belonging to the highest bright bin are positioned at the light bar 30-1 and the light bar 30-2 and closest to the center 30C. The LEDs 60 (the third light group) belonging to the lowest bright bin are positioned at the light bar 30-1 and the light bar 30-2 and farthest to the position center 30C.

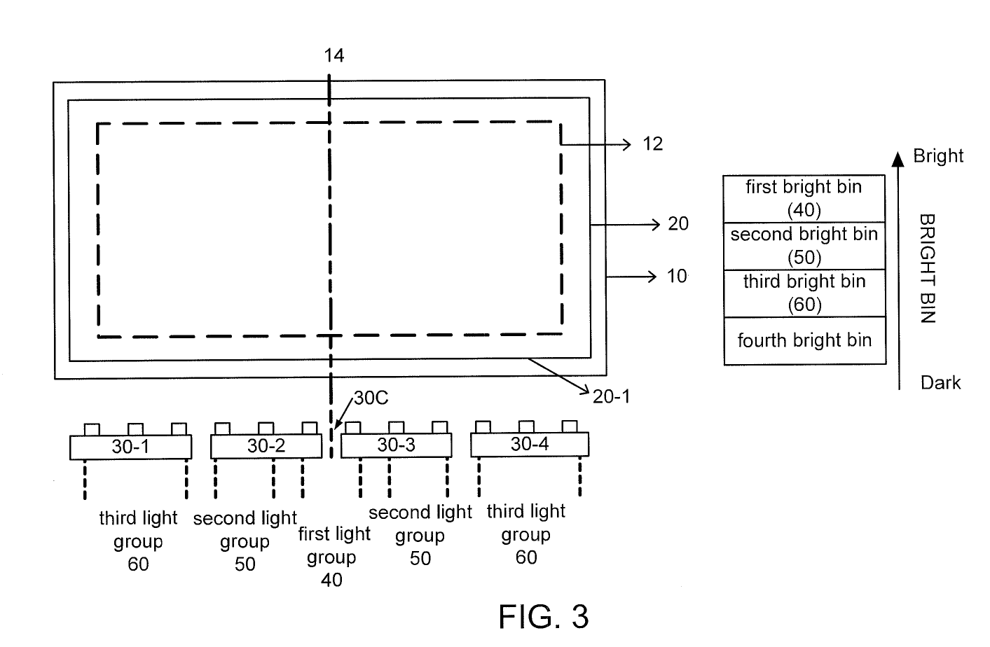

Please refer to FIG. 3, which shows a diagram of a LED backlight module according to the third embodiment of the present invention. The backlight module in this embodiment is a side light type LED backlight module. As shown in the right of FIG. 3, a diagram of that a plurality of LEDs, classified according to bright bin is disclosed. The brightness of the first bright bin is the highest. The brightness of the fourth bright bin is the lowest. The LEDs 40 belong to the first bright bin. The LEDs 50 belong to the second bright bin. The LEDs 60 belong to the third bright bin. The LEDs belonging to the fourth bright bin are darkest and therefore will not be used. The LEDs 40 are arranged as a first light group. The LEDs 50 are arranged as a second light group. The LEDs 60 are arranged as a third light group.

In this embodiment, the LED backlight module comprises a back plate 10, a light guide plate 20, four light bars 30-1, 30-2, 30-3, 30-4 and a plurality of LEDs 40, 50, 60. The back plate 10 is positioned at the bottom of the LED backlight module. The light guide plate 20 is positioned on the back plate 10 in accordance with a display area 12 of the liquid crystal display apparatus and overlaps therewith. The display area 12 has a display area center line 14 (AA area center line). The back plate 10 has an incident side perpendicular to the display center line 14. The incident side has a position center 30C. The light bars 30-1, 30-2, 30-3, 30-4 are symmetrically laid out regarding the position center 30C on the back plate 10 at the incident side of the LED backlight module. The LEDs 40, 50, 60 are positioned on the light bars 30-1, 30-2, 30-3, 30-4 respectively, and face the incident surface 20-1 of the of the light guide plate 20. The light bars 30-2, 30-3 are closer to the position center 30C. The light bars 30-1, 30-4 are farther to the position center 30C. The LEDs 40 (the first light group) are positioned at the light bars 30-2, 30-3 and closest to the center 30C. The LEDs 50 (the second light group) are positioned at the light bars 30-2, 30-3 and farther to the center 30C. The LEDs 60 (the third light group) are positioned farthest to the position center 30C.

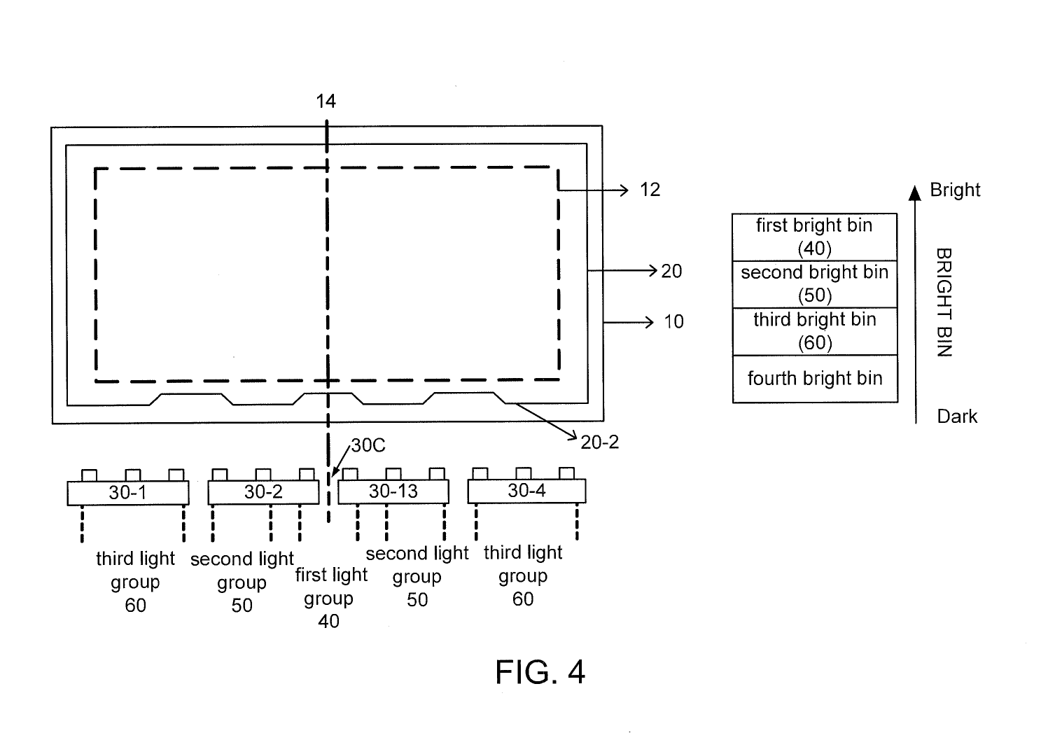

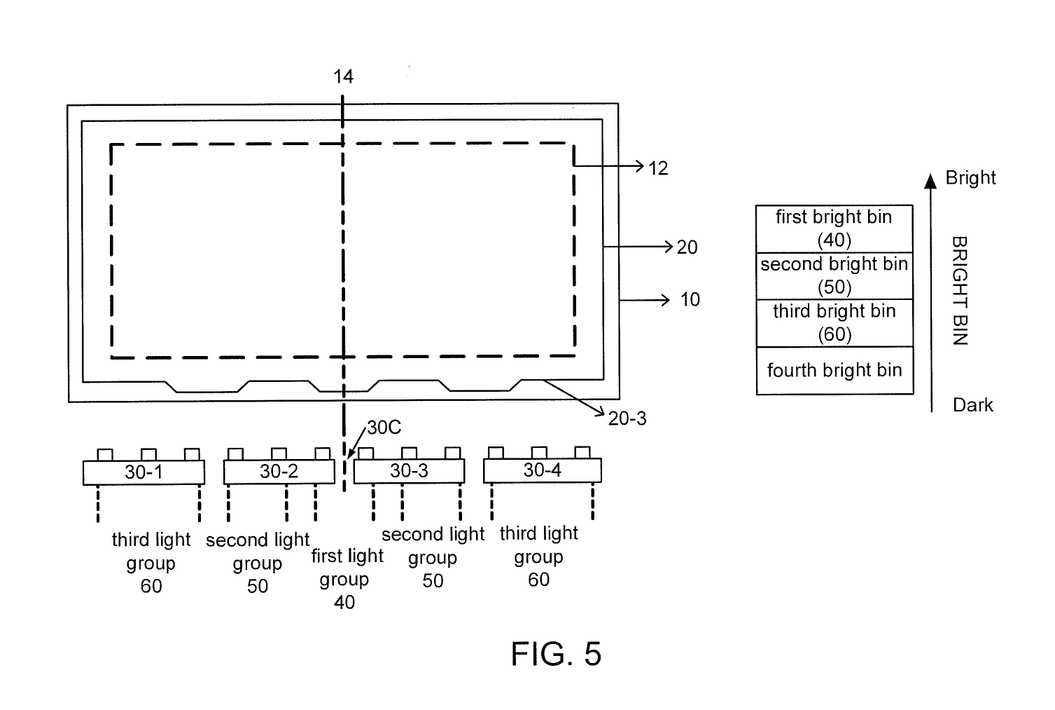

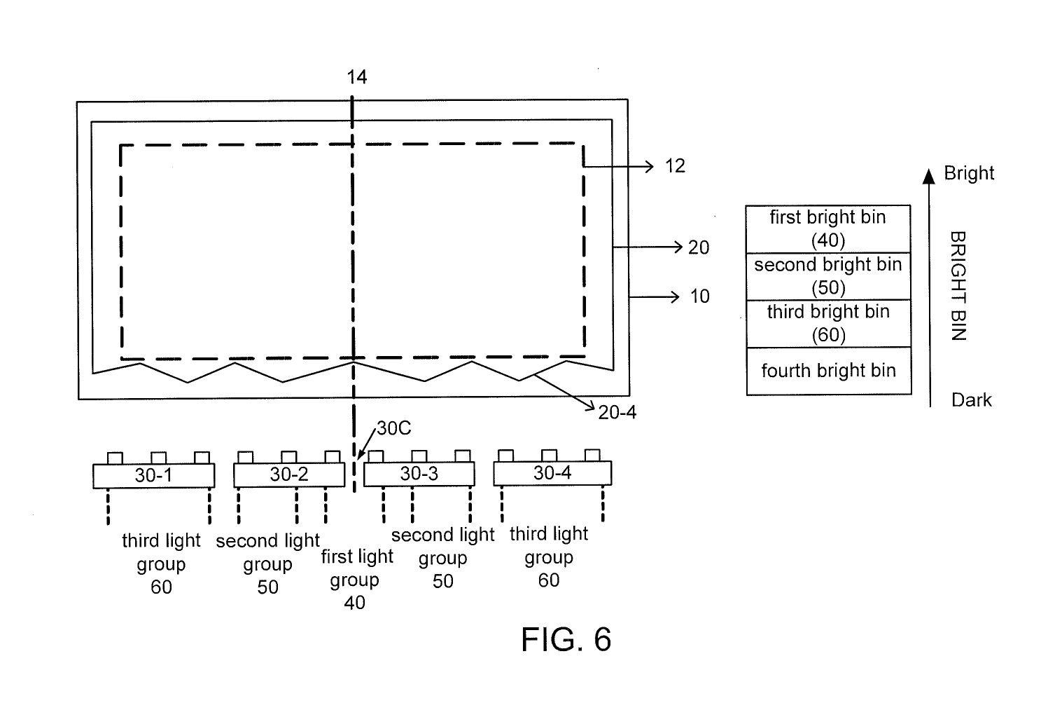

Please refer to FIG. 4, FIG. 5 and FIG. 6, which respectively show LED backlight modules according to the fourth, fifth and sixth embodiments of the present invention. The backlight modules in the fourth, fifth and sixth embodiments are similar to the backlight module in the third embodiment. The differences are that as shown in FIG. 4, the incident surface of the light guide plate 20-2 facing the light bars 30-1, 30-2, 30-3, 30-4 has a plurality of concaves in the fourth embodiment. As shown in FIG. 5, the incident surface of the light guide plate 20-3 facing the light bars 30-1, 30-2, 30-3, 30-4 has a plurality of convexes in the fifth embodiment. As shown in FIG. 6, the incident surface of the light guide plate 20-4 facing the light bars 30-1, 30-2, 30-3, 30-4 is a jagged structure surface in the sixth embodiment.

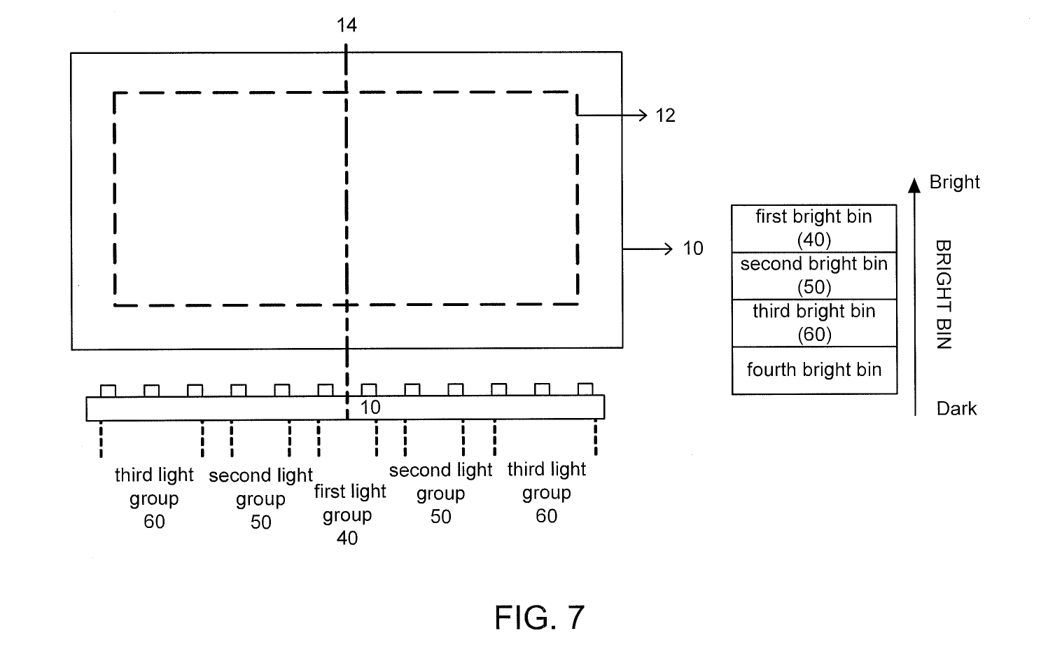

Please refer to FIG. 7, which shows a diagram of a LED backlight module according to the seventh embodiment of the present invention. As shown in the right of FIG. 7, a diagram of that a plurality of LEDs, classified according to bright bin is disclosed. The plurality of LEDs is classified by four bins, the LEDs 40 belonging to the first bright bin, the LEDs 50 belonging to the second bright bin, the LEDs 60 belonging to the third bright bin and the LEDs belonging to the fourth bright bin. The brightness of the first bright bin is the highest. The brightness of the fourth bright bin is the lowest. As shown in FIG. 7, the LEDs belonging to the fourth bright bin are darkest and therefore will not be used. The LEDs 40 (the first light group) belonging to the first bright bin are positioned on the back plate around the display area center line 14. The LEDs 50 (the second light group) belonging to the second bright bin are positioned on the back plate relatively farther to the display area center line 14. The LEDs 60 (the third light group) belonging to the third bright bin are positioned on the back plate farthest to the display area center line 14, i.e. positioned near the other two sides as regarding the incident side perpendicular to the display center line 14.

Moreover, A liquid crystal display apparatus utilizing any of the LED backlight modules described in the first embodiment˜the seventh embodiment.

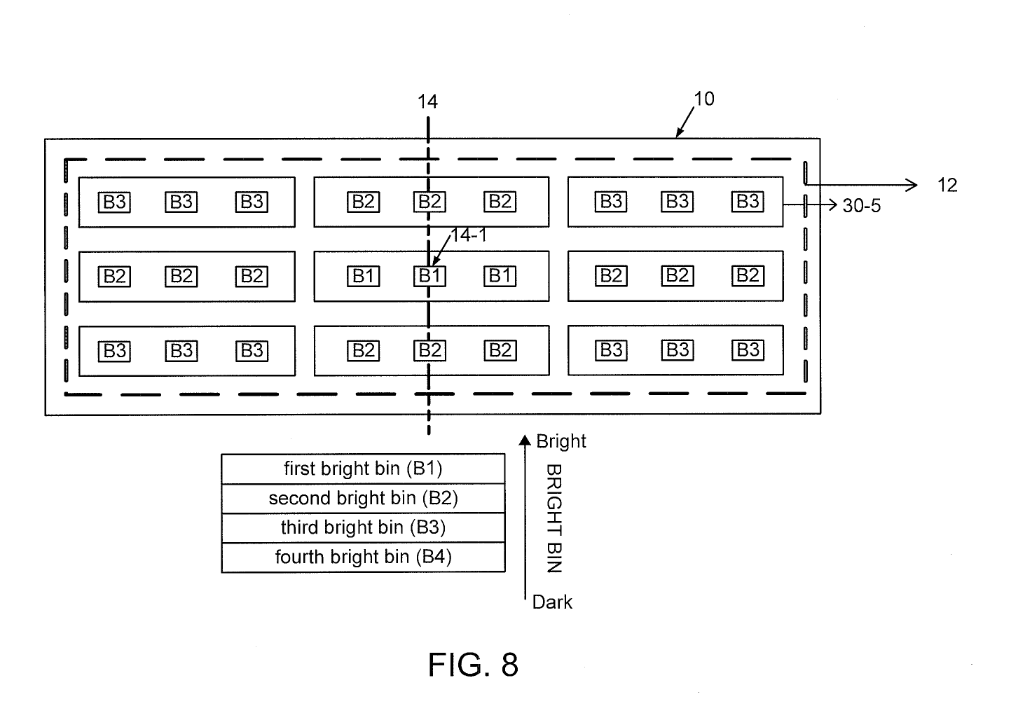

Please refer to FIG. 8, which shows a diagram of a LED backlight module according to the eighth embodiment of the present invention. The present invention can also be applied for a direct light type LED backlight module. The LED backlight module comprises a back plate 10 and a plurality of LEDs 40-60. A plurality of light bars 30-5 is laid out on the back plate 10. As shown in FIG. 8, the LEDs belonging to the fourth bright bin (B4) will not be used. The LEDs belonging to the first bright bin (B1) are positioned on the light bar at the center 14-1. The LEDs belonging to the second bright bin (B2) are positioned on the light bars at the top, the bottom, the left and the right of the center 14-1. The LEDs belonging to the third bright bin (B3) are positioned on the light bars at the upper right, the lower right, the upper left and the lower left of the center 14-1. However, please notice that the amount of the light bars 30-5 is not specifically limited in this embodiment.

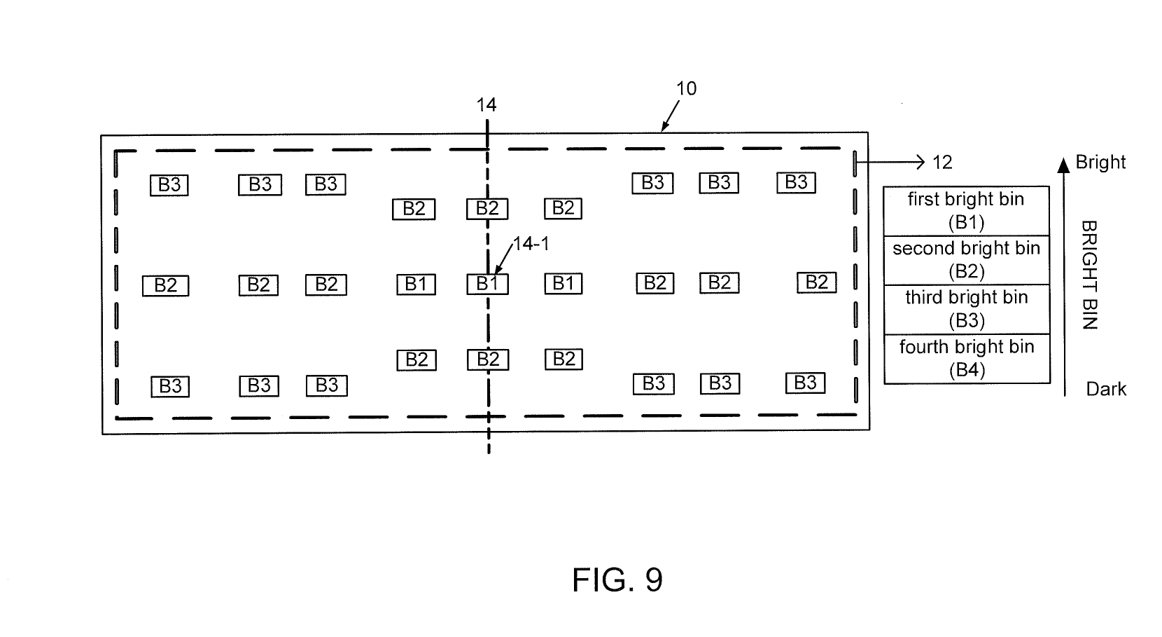

Please refer to FIG. 9, which shows a diagram of a LED backlight module according to the ninth embodiment of the present invention. The backlight module in this embodiment is a direct light type LED backlight module. As shown in the right of FIG. 9, a diagram of that a plurality of LEDs, classified according to positive voltage bin (Vf BIN) is disclosed. The plurality of LEDs is classified into four bins, the first bright bin (B1), the second bright bin (B2), the third bright bin (B3) and the fourth bright bin (B4). The LED backlight module comprises a back plate 10 and a plurality of LEDs 40-60. The ninth embodiment different from the eighth embodiment in the present invention is that the LED backlight module of the ninth embodiment does not comprise any light bars but the LEDs are directly laid out on the back plate 10. As shown in FIG. 9, the LEDs belonging to the first bright bin (B1) are positioned at the center 14-1. The LEDs belonging to the second bright bin (B2) are positioned at the top, the bottom, the left and the right of the center 14-1. The LEDs belonging to the third bright bin (B3) are positioned at the upper right, the lower right, the upper left and the lower left of the center 14-1. However, please notice that that the amounts of LEDs B1, B2, B3, B4 and their positions on the back plate 10 are not specifically limited in this embodiment.

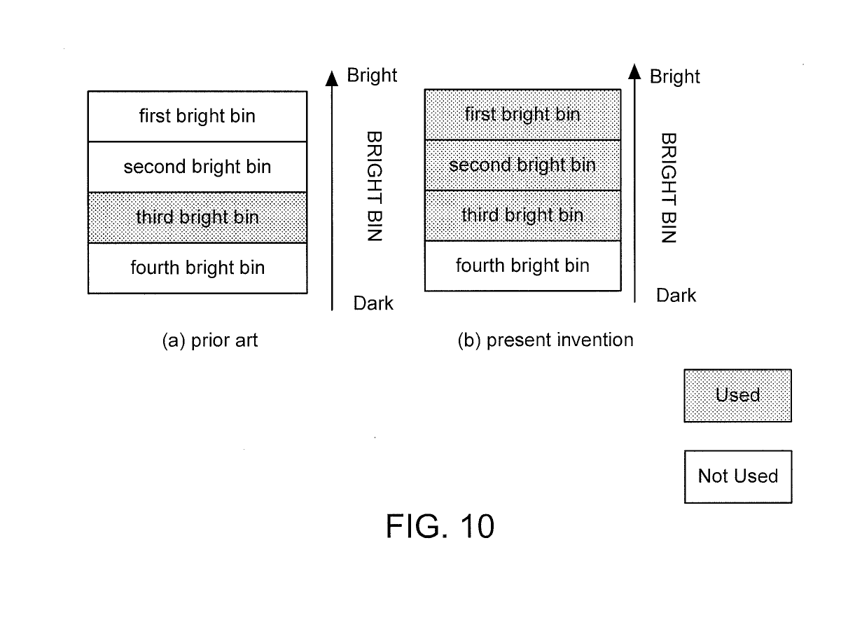

Please refer to FIG. 10, which shows an explanation diagram of raising a usage rate of the LEDs according to the present invention. As shown in FIG. 10(a), a diagram of that a plurality of LEDs for a backlight module, classified according to bright bin in prior art is disclosed. Merely the LEDs belonging to the third bright bin (B3) can be used. However, according to the present invention, the LEDs belonging to the first, second and third bright bins can be used for the backlight module. Furthermore, according to the first embodiment˜the ninth embodiment in the present invention, the LEDs belonging to a higher bright bin are positioned closer to the position center and the LEDs belonging to a lower bright bin are positioned farther to the position center. Moreover, the present invention can utilize white LEDs or can mix LEDs of other colors. Therefore, the usage rate of the LEDs utilized for manufacturing the liquid crystal display apparatus and the backlight module can be raised to reduce the cost. Meanwhile, the non-uniformity issues of brightness and chrominance of the LEDs can be promoted. Accordingly, the brightness and chrominance at the center and the brightness and chrominance at periphery in the liquid crystal display apparatus can be more uniformly equivalent.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A backlight module, used for a liquid crystal display apparatus, characterized in that the backlight module comprises:
a back plate, positioned at the bottom of the backlight module;
a display area, being in the liquid crystal display apparatus in accordance with the back plate and overlapping therewith, and the display area has a display area center line; and
a plurality of LED, classified to belong to several bright bins respectively and the display area center line has a center corresponding to the LEDs, wherein the LEDs belonging to a higher bright bin are positioned closer to the center and the LEDs belonging to a lower bright bin are positioned farther to the center.

2. The backlight module of claim 1, characterized in that the backlight module is a direct light type LED backlight module.

3. The backlight module of claim 2, characterized in that the backlight module further comprises a plurality of light bars positioned on the back plate and the LEDs are positioned on the light bars.

4. The backlight module of claim 3, characterized in that the center of the display area center line corresponding to the LEDs is substantially at a center position of the back plate.

5. The backlight module of claim 4, characterized in that the light bars are symmetrically laid out regarding the center and the LEDs are classified into several light groups in accordance with the several bright bins, wherein a light group belonging to a higher bright bin are positioned on a light bar closer to the center and a light group belonging to a lower bright bin is positioned on a light bar farther to the center, and a light group belonging to a bright bin between the higher bright bin and the lower bright bin is positioned between the light group belonging to higher bright bin and the light group belonging to the lower bright bin.

6. The backlight module of claim 2, characterized in that the LEDs are directly laid out on the back plate.

7. The backlight module of claim 1, characterized in that the backlight module is a side light type LED backlight module, and the side light type LED backlight module further comprises a light guide plate, and the light guide plate and the back plate are positioned in accordance with the display area and overlap therewith.

8. The backlight module of claim 7, characterized in that the backlight module further comprises at least one light bar positioned at a side of the display area perpendicular to the display area center line corresponding to the light guide plate, and the LEDs are positioned on the at least one light bar.

9. The backlight module of claim 8, characterized in that the at least one light bar is symmetrically laid out regarding the center and the LEDs are classified into several light groups in accordance with the several bright bins, wherein a light group belonging to a higher bright bin are positioned on a light bar closer to the center and a light group belonging to a lower bright bin is positioned on a light bar farther to the center, and a light group belonging to a bright bin between the higher bright bin and the lower bright bin is positioned between the light group belonging to higher bright bin and the light group belonging to the lower bright bin.

10. The backlight module of claim 9, characterized in that the light groups respectively comprise LEDs classified to belong to the same bright bin.

11. The backlight module of claim 7, characterized in that the light guide plate facing an incident surface of the at least one light bar is a plane or a jagged structure surface.

12. The backlight module of claim 8, characterized in that the light guide plate facing an incident surface of the at least one light bar is a plane or a jagged structure surface.

13. The backlight module of claim 9, characterized in that the light guide plate facing an incident surface of the at least one light bar is a plane or a jagged structure surface.

14. The backlight module of claim 10, characterized in that the light guide plate facing an incident surface of the at least one light bar is a plane or a jagged structure surface.

15. The backlight module of claim 7, characterized in that the light guide plate facing an incident surface of the at least one light bar comprises a plurality of concaves or a plurality of convexes.

16. The backlight module of claim 8, characterized in that the light guide plate facing an incident surface of the at least one light bar comprises a plurality of concaves or a plurality of convexes.

17. The backlight module of claim 9, characterized in that the light guide plate facing an incident surface of the at least one light bar comprises a plurality of concaves or a plurality of convexes.

18. The backlight module of claim 10, characterized in that the light guide plate facing an incident surface of the at least one light bar comprises a plurality of concaves or a plurality of convexes.

19. The backlight module of claim 2, characterized in that the LEDs are white light LEDs.
